(19) United States
(12) Patent Application Publication
(10) Pub. No.: US 2003/0041281 A1
(43) Pub. Date: Feb. 27, 2003

(54) Data analysis system

(76) Inventor: Brian Patrick Nestor, Victoria (AU)

Correspondence Address: NIXON & VANDERHYE P.C., 8th Floor, 1100 North Glebe Road, Arlington, VA, 22201, US

(21) Appl. No.: 10/197,257

(22) Filed: Jul. 18, 2002

(30) Foreign Application Priority Data
Jul. 18, 2001 (AU) PR6424/01

(51) Int. Cl. G06F 3/00

(52) U.S. Cl. 714/5; 710/1

(57) ABSTRACT

A data analysis system, including means for retrieving a binary image of a first data storage medium, the image being an unaltered binary replica of the bits of the first storage medium; means for storing the image on a second storage medium, the image being stored as a single binary file on the second storage medium; and means for analysing said image on said second storage medium.

### TECHNICAL FIELD

The present invention relates to a system and method of data analysis, and to a system and method of data analysis for use in data recovery.

### BACKGROUND OF THE INVENTION

A data recovery program, operating on a first hard disk, may communicate with a client hard disk coupled to an IDE (Integrated Data Electronics) port of the first hard disk, if a common operating system and file structure exists between the two hard disks. Easy Recovery; Tiramisu; Search & Rescue and Lost & Found are examples of data recovery programs that are able to communicate with a client hard disk in the described manner. A person who specialises in recovering data from computers may therefore use a number of computers, one suitable for use with each type of client hard disk.

The above data recovery techniques involve the first hard disk interacting with the client hard disk to recover the data. These techniques may involve the step of parsing the client hard disk and rebuilding the file structure of the client hard disk. It may be necessary for the purposes of forensic examination of the client hard disk, for example, to ensure that the integrity of the client hard disk is maintained. As such, the data recovery techniques may not be suitable for use in forensic purposes.

Other data recovery programs may create an image of the client hard disk on a separate hard disk. Such data recovery programs typically make a binary copy of the client hard disk, save it as an image on the separate hard disk and then use appropriate analysis techniques to recover the data on the image of the client hard disk. Data recovery systems which use this technique, generally split any image greater than 2 Gigabytes (Gb), for example, into a number of files. So that these files maintain their order, header and footer information is appended to each file. It may, however, be necessary for the purpose of forensic analysis of the client hard disk, for example, that the integrity of the image not be compromised by appending additional data to the image file(s) stored on the separate hard disk.

It is desired to provide a system to obviate one or more of the difficulties or disadvantages associated with the above or at least provide a useful alternative.

### SUMMARY OF THE INVENTION

In accordance with the present invention there is provided a data analysis system, including:

means for retrieving a binary image of a first data storage medium, the image being an unaltered binary replica of the bits of the first storage medium;

means for storing the image on a second storage medium, the image being stored as a single binary file on the second storage medium; and

means for analysing said image on said second storage medium.

Preferably, the means for analysing includes means for identifying an operating system and file structure of said image.

Preferably, the data analysis system includes means for recovering data from the image in a form readable by an operating system and storing the recovered data on a third data storage medium.

In accordance with the present invention there is also provided a method of data analysis, including the steps of:

retrieving a binary image of a first data storage medium, the image being an unaltered binary replica of the bits of the first storage medium;

storing the image on a second storage medium, the image being stored as a single binary file on the second storage medium; and

analysing the image on the second storage medium.

Preferably, the step of analysing includes the step of identifying an operating system and file structure of said image.

Preferably, the method includes the steps of recovering data from the image in a form readable by an operating system and storing the recovered data on a third data storage medium.

In accordance with the present invention there is also provided a data analysis method, including the steps of:

accessing a binary file comprising a binary image of the binary bits of a data storage medium; and

identifying an operating system and file structure of said image.

Preferably, the method includes the steps of recovering data from the image in a form readable by an operating system and storing the recovered data on a further data storage medium.

Preferably, the method includes the step of storing said file structure and recovered data on return media.

In accordance with the present invention there is also provided a data recovery system, including:

means for retrieving a binary image of a first data storage medium, the image being an unaltered binary replica of the bits of the first storage medium; and

means for storing the image on a second storage medium, the image being stored as a single binary file on the second storage medium.

Preferably, the data recovery system includes means for analysing said image on said second storage medium.

Preferably, the data recovery system includes means for recovering data from the image in a form readable by an operating system and storing the recovered data on a third data storage medium.

Advantageously, the data storage mediums may be computer hard disks, in excess of 10 Gb in size.

### BRIEF DESCRIPTION OF THE DRAWINGS

A preferred embodiment of the invention is herein after described, by way of non-limiting example only, with reference to the accompanying drawings wherein:

FIG. 1 is an illustration of a computer analysis system in accordance with the invention;

FIG. 2 shows a block diagram of the computer analysis system shown in FIG. 1;

FIG. 3 shows a Login display generated by the computer analysis system;

FIG. 4 shows an Administration display generated by the computer analysis system;

FIG. 5 shows the screens that the computer analysis system can generate for a non-administrative user;

FIG. 6 shows a Client Contact display generated by the computer analysis system;

FIG. 7 shows a Client Data display generated by the computer analysis system;

FIG. 8 shows a Media Select display generated by the computer analysis system;

FIG. 9 shows screens generated by the computer analysis system from the Media Select display of FIG. 8;

FIG. 10 shows a Replication display generated by the computer analysis system;

FIG. 11 shows a Hex Viewer display generated by the computer analysis system from the Replication display of FIG. 10;

FIG. 12 shows a Data Recovery display generated by the computer analysis system;

FIG. 13 shows a File System Analyser display generated by the computer analysis system from the Data Recovery display of FIG. 12;

FIG. 14 shows a Select Capture Destination display generated by the computer analysis system from the File System Analyser display of FIG. 13;

FIG. 15 shows a Find and Capture display generated by the computer analysis system from the File System Analyser display of FIG. 13;

FIG. 16 shows a Return Media display generated by the computer analysis system;

FIG. 17 shows a Log Viewer display generated by the computer analysis system;

FIG. 18 shows a Log Viewer display generated by the computer analysis system; and

FIGS. 19 and 20 show a flow diagram of steps executed by the computer analysis system.

### DETAILED DESCRIPTION OF THE PREFERRED EMBODIMENT

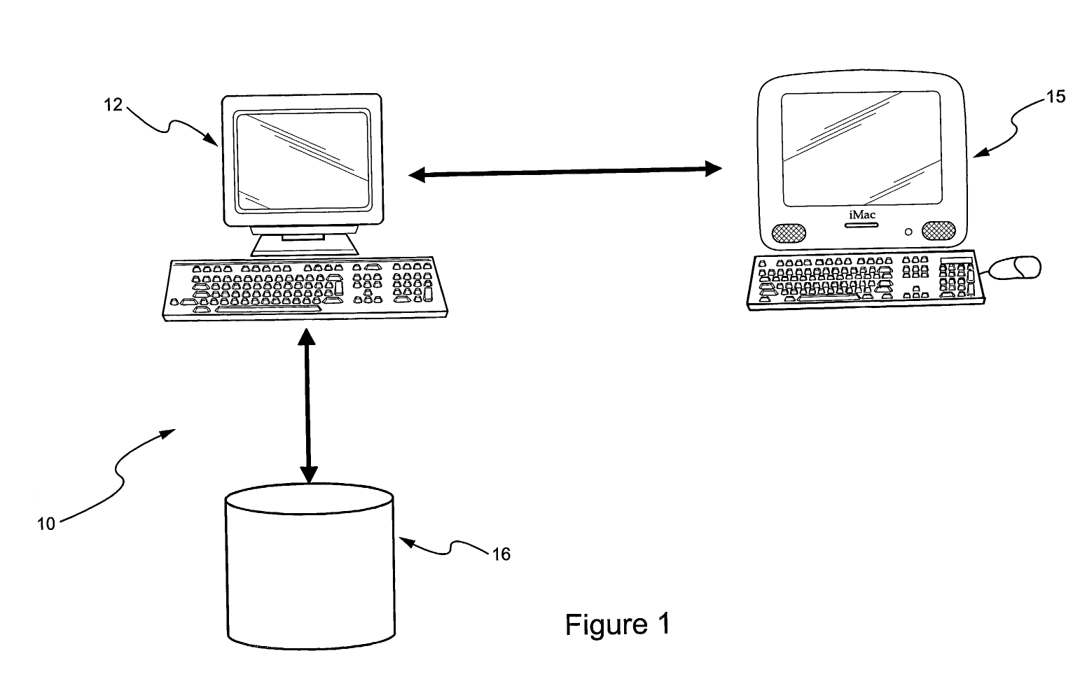

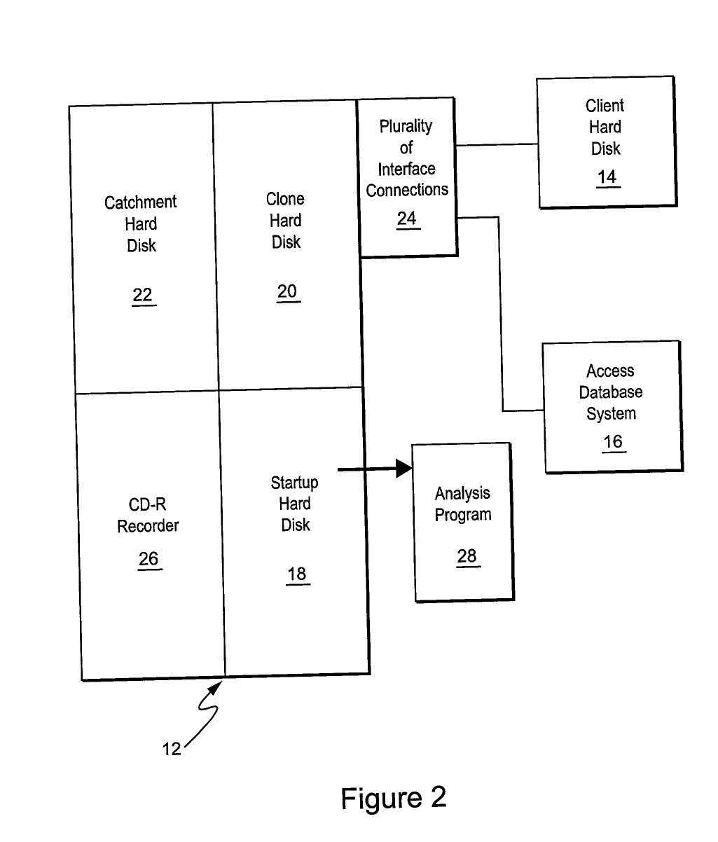

A computer analysis system 10, as shown in FIG. 1, includes an analysis computer 12; and an Access database system 16, that can be connected to a hard disk 14 of a client computer 15. The analysis computer 12, as shown in FIG. 2 includes a startup hard disk 18; a clone hard disk 20; a catchment hard disk 22; a plurality of interface connections 24 and a CD-R recorder 26.

The analysis computer 12 is a PC that runs from the startup hard disk 18 one of the following operating systems:

(i) Windows 95;

(ii) Windows 98;

(iii) Windows ME;

(iv) Windows NT Workstation;

(v) Windows NT Server;

(vi) Windows NT Advanced Server;

(vii) Windows NT Enterprise Edition

(viii) Windows 2000 Professional or

(ix) Windows 2000 Server.

(x) Windows XP all Versions

The client hard disk 14 may have been formatted by any or all of the following operating systems:

(i) MS-DOS;

(vii) PC-DOS;

(xiii) DR-DOS;

(ii) Caldera DOS;

(iii) Windows 98 SE;

(iv) Sun Solaris;

(v) OS/2;

(vi) BOS;

(viii) Windows 2000;

(ix) MAC OS;

(x) BSD;

(xi) Linux;

(xii) MOS;

(xiv) Unix;

(xv) BeOS;

(xvi) XENIX;

or (xvii) CDOS.

The client hard disk 14 may then have any of the following corresponding file structures:

(i) FAT12;

(ii) FAT 32;

(iii) HFS+;

(iv) FAT16;

(v) NTFS;

(vi) Ext2FS;

(vii) VFAT;

(viii) HFS;

(ix) UFS; or

(x) NetWare File Systems (NFS).

The plurality of connections 24 provide a variety of possible interface ports, one of which can be selected to connect the client hard disk 14 to the analysis computer 12. The interface connections 24 include the following ports:

(i) IDE Primary Master;

(ii) IDE Primary Slave;

(iii) IDE Secondary Master;

(iv) IDE Secondary Slave;

(v) Promise ATA 66/100, Adaptec, Symbios and Mylex RAID controllers;

(vi) SCSI Lun0-Lun6-Ids 0-15 for each;

(vii) PCMCIA

(viii) Cat5 UTP-TCP/IP and Net Bios;

(ix) Fire Wire;

(x) Parallel;

(xi) Serial; and

(xii) USB.

The startup hard disk 18 running on a Windows NT 4 operating system, for example, includes a pointer to an executable copy of an analysis program 28 in the following path of the “Registry Editor”:

My Computer\HKEY_LOCAL_MACHlNE\SOFTWARE\Microsoft\Windows\CurrentVersion\Run

The analysis program 28 therefore runs automatically when the analysis computer 12 is booted.

Typically, the Access database of the database system 16 is stored on a separate computer and the separate computer functions as a server for the analysis computer 12.

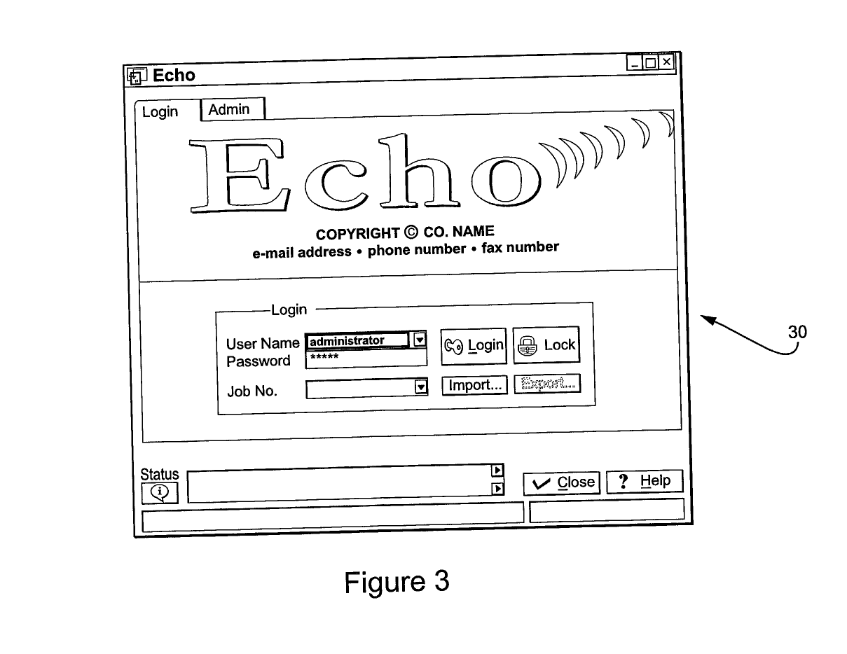

The steps executed by the analysis program 28 are herein after described with reference to the FIGS. 3 to 18. It will be apparent to those skilled in the art that whilst the implementation discussed is a software embodiment of the analysis program 28, the steps of the program maybe executed at least in part by dedicated hardware elements, such as ASICs or micro-coded chips.

In use of the computer analysis system 10, a user switches the analysis computer 12 “on” and waits for the analysis program 28 to load as described above. The analysis program 28 greets the user of the computer analysis system 12 with a Login display 30, as shown in FIG. 3. The Login screen 30 prompts the user of the computer analysis system 10 for their user name, password and corresponding job number.

An administrator of the computer analysis system 10 logs onto the analysis program 28 by inserting a key or “dongle” into the analysis computer 12; entering their name as “Administrator” and then entering their password.

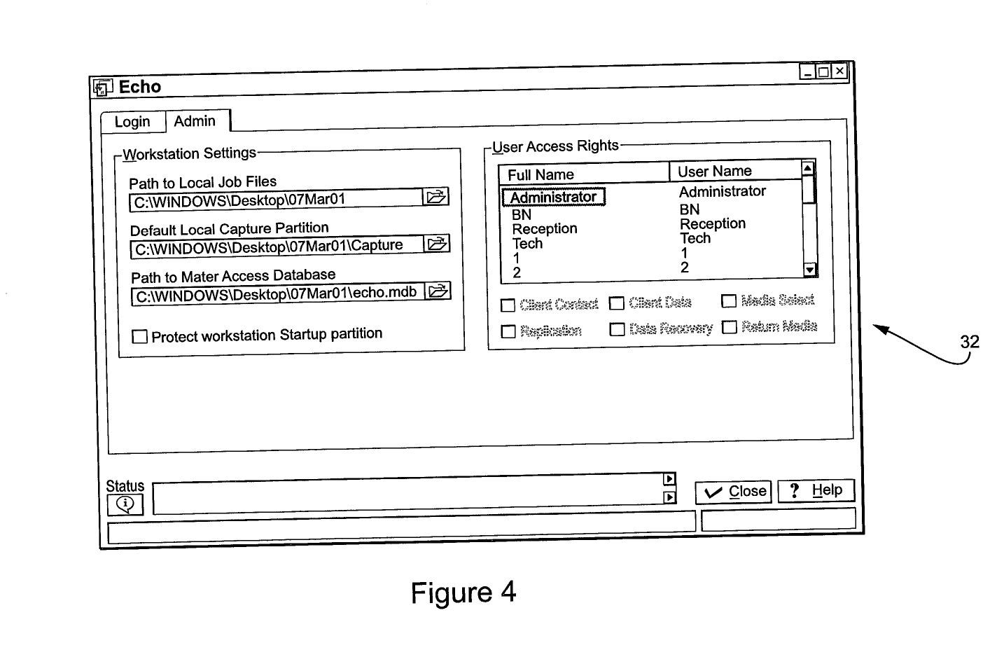

The analysis program 28 verifies the user as a bona fide administrator and allows the user to access an Administration display 32, as shown in FIG. 4, for the present job number.

The Administration display 32 allows an administrator to set a default directory for the replica data on the clone hard disk 20 and a default path to the Access database 16.

Further, the Administration display 32 allows an administrator to declare which users are allowed to access jobs and to set acccss rights to the analysis program 28 for each of those users.

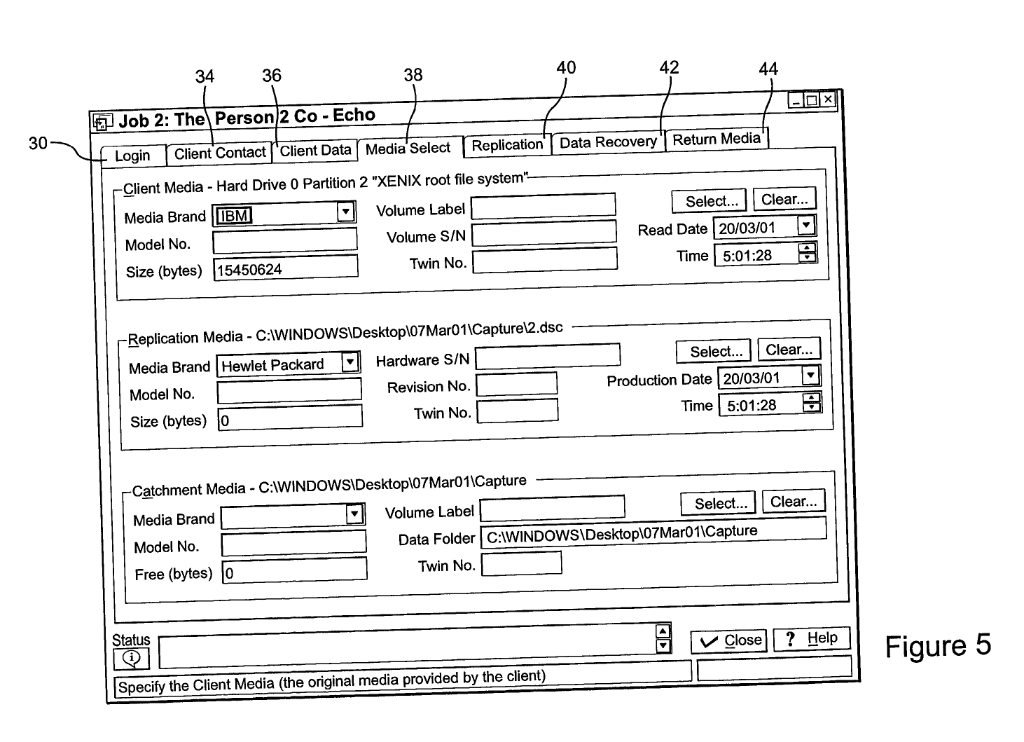

For each job number, the analysis program 28 may allow a user to access a respective Client Contact display 30; a Client Data display 36; a Media Select display 38; a Replication display 40; a Data Recovery display 42 and a Return Media display 44, as shown in FIG. 5.

A non-administrative user of the analysis program 28 logs into the analysis computer 28 from the login display 30 by entering their respective user name and password and the relevant job number. The analysis program 28 verifies the user's details and generates the displays that the user is allowed to access for the respective job number.

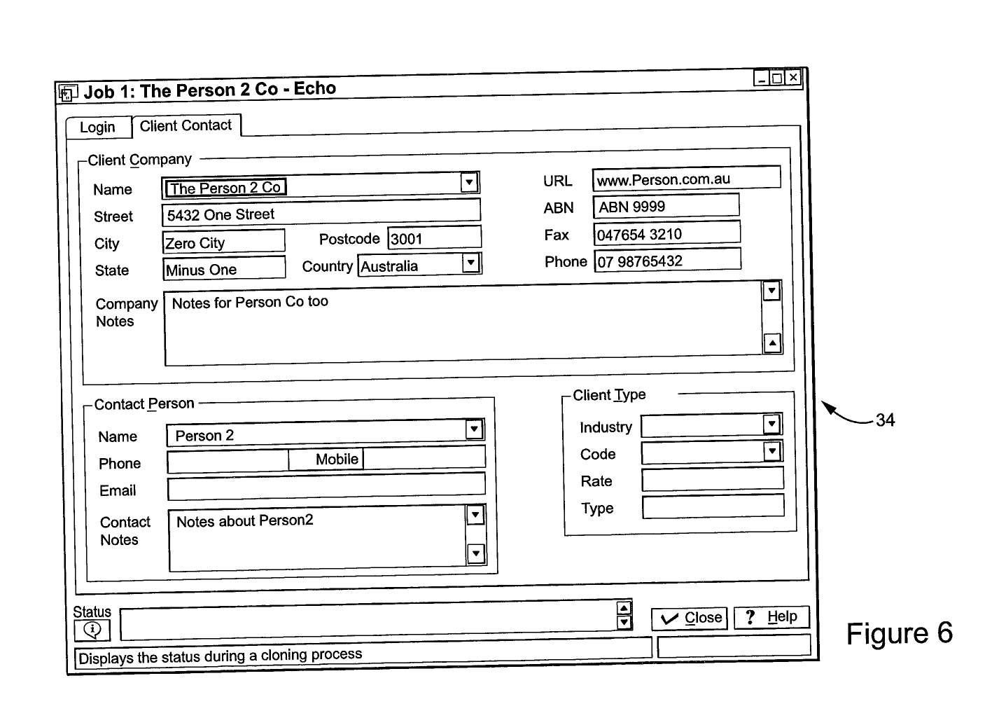

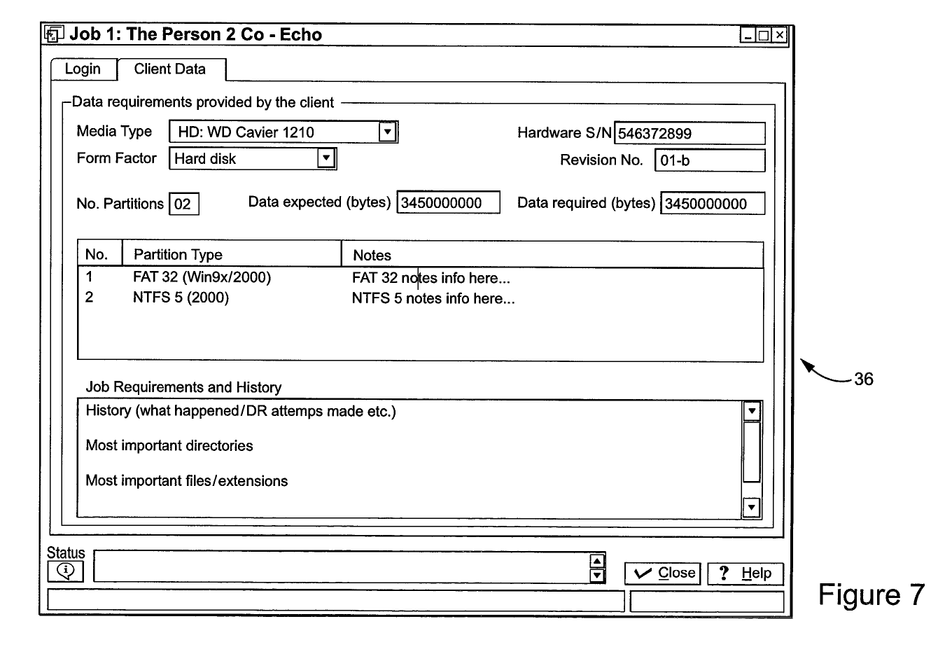

Client contact details and associated information about a particular job number are entered into the analysis computer 12 via the Client Contact display 34, as shown in FIG. 6, and a Client Data display 36, as shown in FIG. 7.

Typically, a user with permission to access these displays 34, 36 is prompted to enter client company details; client contact details; data requirements; job requirements and a brief history about the job. The data requirements include following types of information:

Client Media Information:

media brands/model/size;

operating system information;

partition information;

file structure information;

Clone Media information:

drive/brand/model/size

Catchment Media information:

drive brand/model/size

Failed Media Information

All of the above-mentioned data is stored as a record, preferably indexed by job number, in the Access Database 16. A user of the analysis program 28 may access and modify the above mentioned information at any time after it has been entered into the Access database 16.

Once the above-mentioned manual data entries have occurred the analysis program 28 is in a position to begin analysis of the client hard disk 14. The analysis computer 12 is turned off and the client hard disk 14 is connected to the analysis computer via the IDE secondary port 24, for example. Once the client hard disk 14 is connected to the analysis computer 12, the analysis computer is then switched on and the analysis program is automatically loaded in the above mentioned manner.

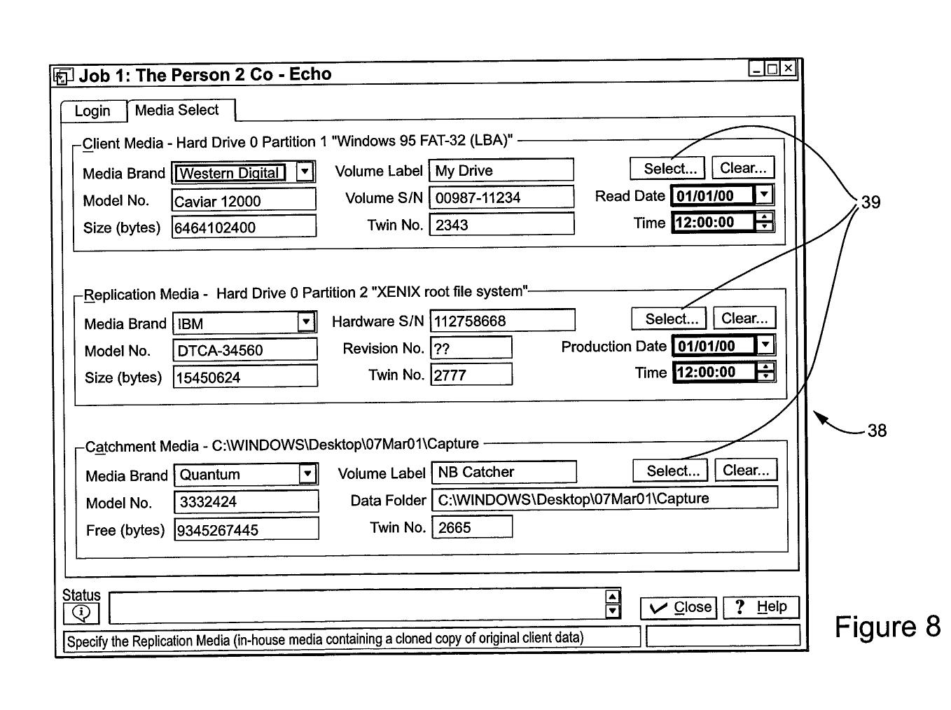

A user with permission to access the Media Select display 38 for the current job number logs onto the analysis computer 12 and views the Media Select display 38, as shown in FIG. 8.

The Media Select display 38 provides a select function 39 that presents information automatically discovered about the client hard disk 14 to the user, where possible, together with information about the clone hard disk 20 and the catchment disk 22.

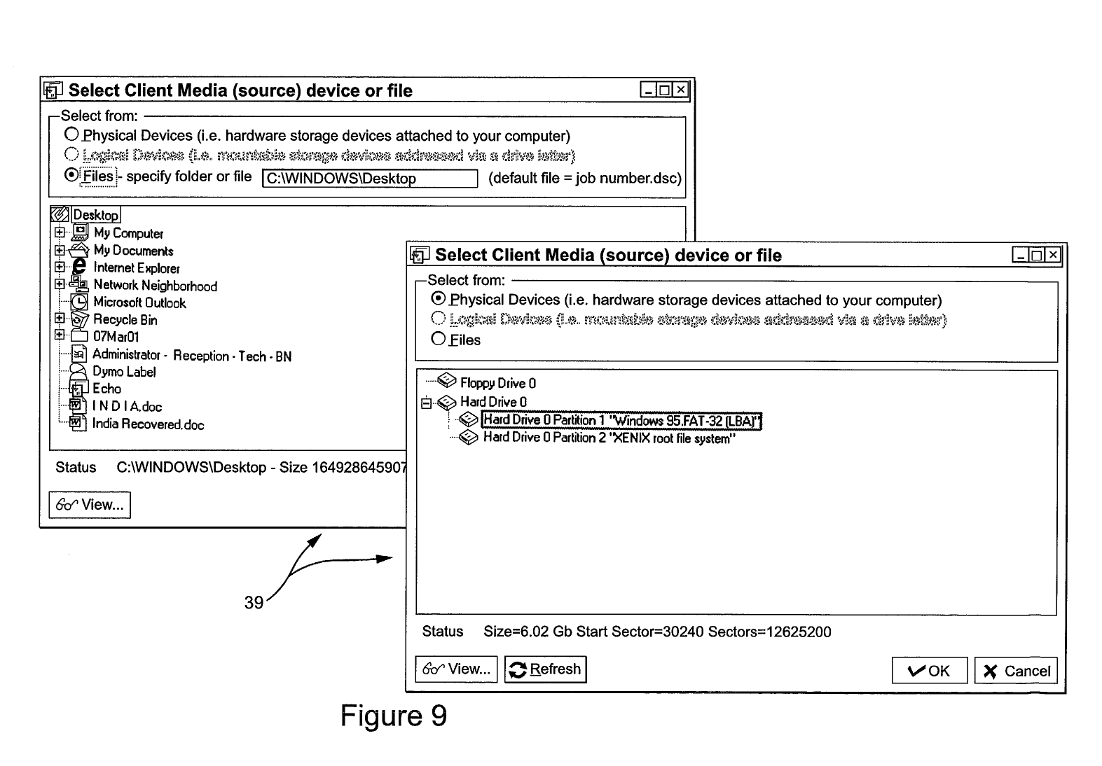

The Media Select display 38 allows the user to select the location of the client hard disk; the clone hard disk 20 and the catchment hard disk 22 via respective “Select” buttons 39. The client hard disk 14, for example, may be selected as a file on the analysis computer with a path “c:\windows\Desktop”, as shown in FIG. 9, or the client hard disk 14 may be selected as a physical device attached to the analysis computer 12, as shown in FIG. 9. To assist in this process, the user is supplied with a list of standardised operating system identifiers.

All of the information accumulated thus far, through the Client Contact display 34; the Client Data display 36 and the Media Select display 38, is saved in the Access database 16, preferably by the job number.

After the above described information gathering processes have been completed, the computer analysis program 26 is then able to clone the client hard disk 24 onto the clone hard disk 16.

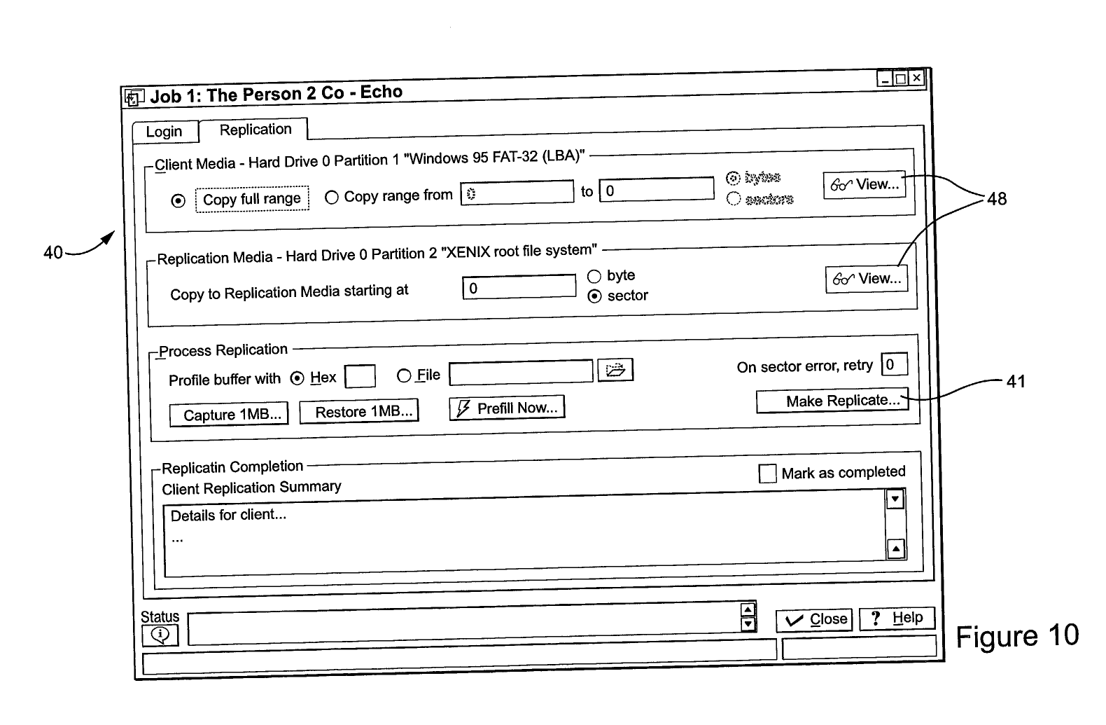

A user with permission to access the Replication Screen 40 of the analysis program 28, as shown in FIG. 10, is able to set various parameters for cloning and execute the cloning operation. For example, the user is able to select the range of data to be copied and the technique by which the client data will be copied, ie either by byte or by sector. The user is also able to nominate which byte or sector that the copying will start at on the clone hard disk 20, thereby allowing an offset in the cloned data, if required.

The Replication screen 40 also provides a washing function for writing a known data pattern to the clone hard disk 20 before the image of the client hard disk 14 is written to it. Hexidecimal zeros may be written to the clone hard disk 20, for example, as a single task or, alternatively, hexidecimal zeros may be written to the clone hard disk 20 in blocks. When the hexidecimal zeros are written in blocks, 4 bytes of memory are washed on the clone hard disk 20 and then 4 bytes of cloned data are written over washed memory. Optionally, other data patterns can be written to the clone media 20, including a user selectable file that can be repeated throughout the cloned disk.

Once the above mentioned parameters for cloning have been set, the user executes the cloning process by clicking the “Make Replicate” button 41 on the Replication screen 40. The cloned data is extracted from the client hard disk 14 and is stored as a binary data file (or a binary replicate), on the clone hard disk 20 as an exact image of the client hard disk 14. It includes the file structure of the client hard disk 14. A record of the cloned data is stored by job number on the Access database 16. The cloned data stored in the single binary file is an exact binary replicate of the binary bits of the client hard disk. From this the data analysis program is able to rebuild and recreate the disk by parsing the data in order to rebuild the file structure of the client hard disk, as described below.

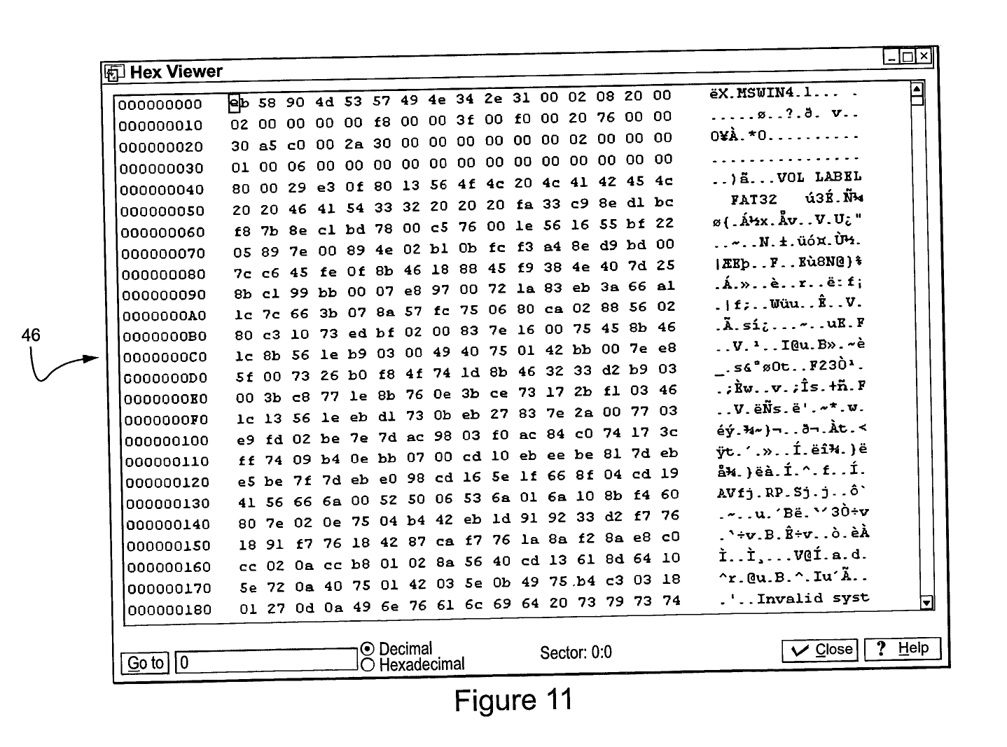

A Hexidecimal/ASCII editor 46 is incorporated for viewing/editing the cloned data, as shown in FIG. 11. This function is available from the Replica display 40 via the “View” button 48. Where the client hard disk 14 is partially unreadable, an extended read function is implemented with a user (re)definable number of retries at reading the client data. In the event of a read error, after the designated multiple retries, the computer analysis program 28 will write hexidecimal zeros to the destination until there is no longer a read error.

The Hexidecimal/ASCII editor 46 has the standard right mouse click options Edit/Copy/Cut/Paste/Select All etc.

Once the cloned data stored on the cloned hard disk 16 is readable, the cloned data can be interrogated to recover the client data.

After cloning the client hard disk 14 has been effected, the following menu is displayed by the analysis program 28 to the user:

Dismount the client and the clone drives?

Apply new serial number to the clone drive and reboot?

Shut down-remove the client drive and reboot?

Dismounting the client and clone drives 14, 20 and applying a new serial number to the clone drive avoids the technical problem of there being two identical Volume serial numbers operational at the same time. Applying a new serial number to the clone drive and rebooting the computer analysis program 28 allows Windows to read the clone drive 20 as if it were the client drive 14.

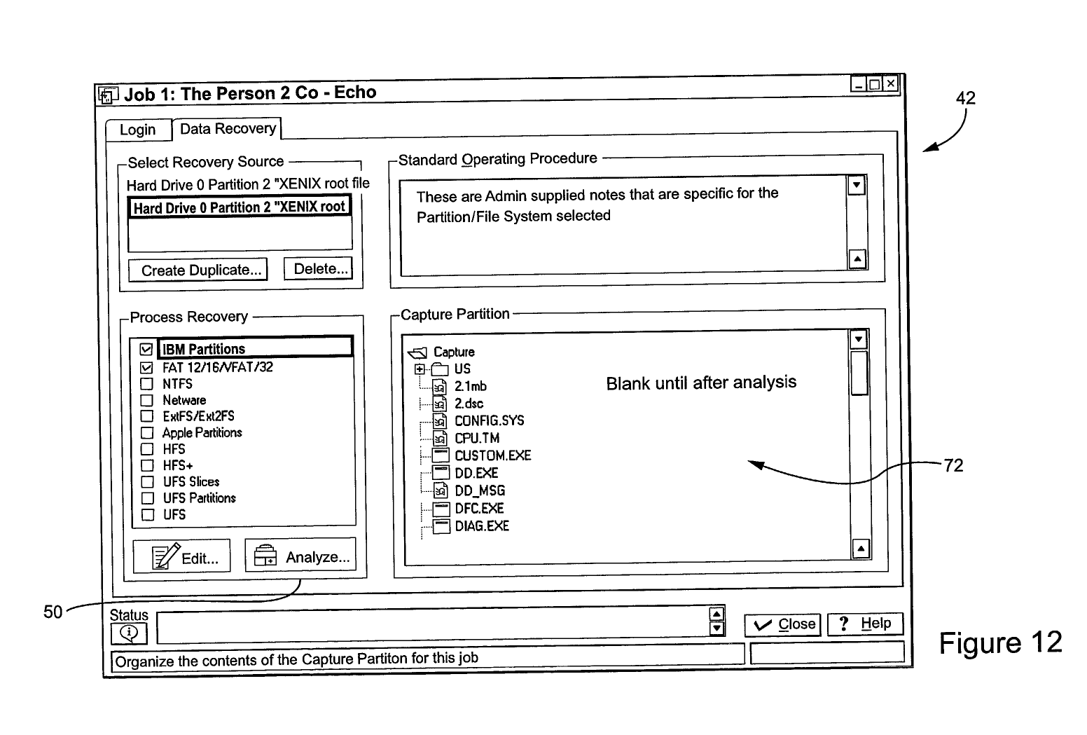

Users of the computer analysis system 10 who have the requisite permission, may access a Data Recovery display 42, as shown in FIG. 12. The Data Recovery display 42 provides tools for a user to analyse/recover the cloned data on the clone hard disk 20. The Data Recovery display 42 allows a user to select the most applicable partitions and file system structures for the cloned data in order to speed up the recovery process.

The Data Recovery display 42 includes an “Analyse” button 50 which, when activated, automatically searches the image of the client hard disk 14 to reconstruct the partitions and file systems in the image.

The Data Recovery display interprets the cloned image of the client hard disk 14 in the binary file as a virtual client hard disk. The analysis program 28 identifies the operating system (if present) and file structure of the image of the client hard disk and then examines that file as though it were made up of the relevant:

(a) Boot Sector(s);

(b) Partition Table(s);

(c) File Allocation Table(s);

(d) Master File Table(s);

(e) File Entry Table(s);

(f) Root Directories;

(g) Child Directories;

(h) Files;

(i) File Fragments;

(j) Deleted Data Directories; and

(k) Orphaned Data Directories.

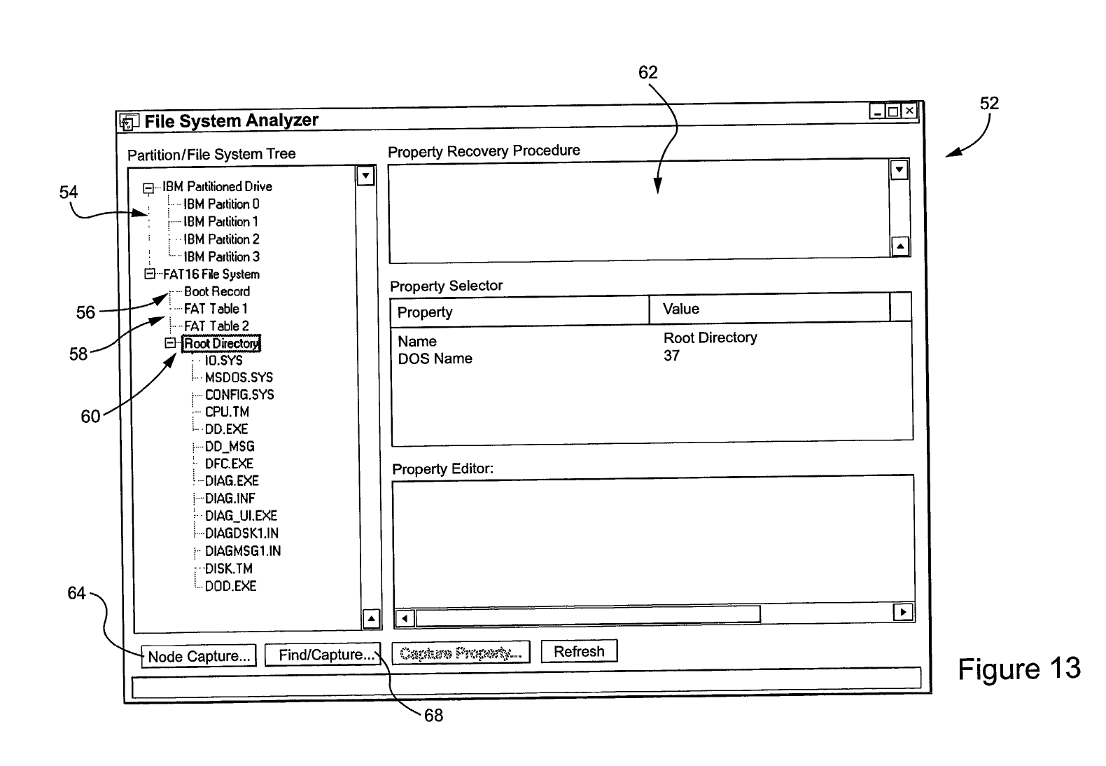

The analysis program 28 displays the results of this search on a File System Analyser display 52 in a “Windows Explorer” type layout, as shown in FIG. 13, for further analysis. This post analysis display shows the partitions 54; the boot record file 56; file allocation tables 58; and the root directory 60 of the image of the client hard disk.

The File System Analyser display 52 suggests a course of action 62 for recovering the client hard disk image where possible.

When the file structure of the client hard disk 14 is not compatible with the operating system and the file structure of the analysis computer 12, the analysis program 28 uses a cross-platform viewer to view the image of the client hard disk. If the client hard disk 14 uses another operating system or a non-Intel or non-Macintosh based structure, the analysis program 28 may not always be able to recover files. However, the computer analysis system 10 will assist the user to produce a text based procedures outline to be later applied as a manual for those platforms. These outlines are built up on the system over time to act as an advisory structure for a user to maintain a consistent approach.

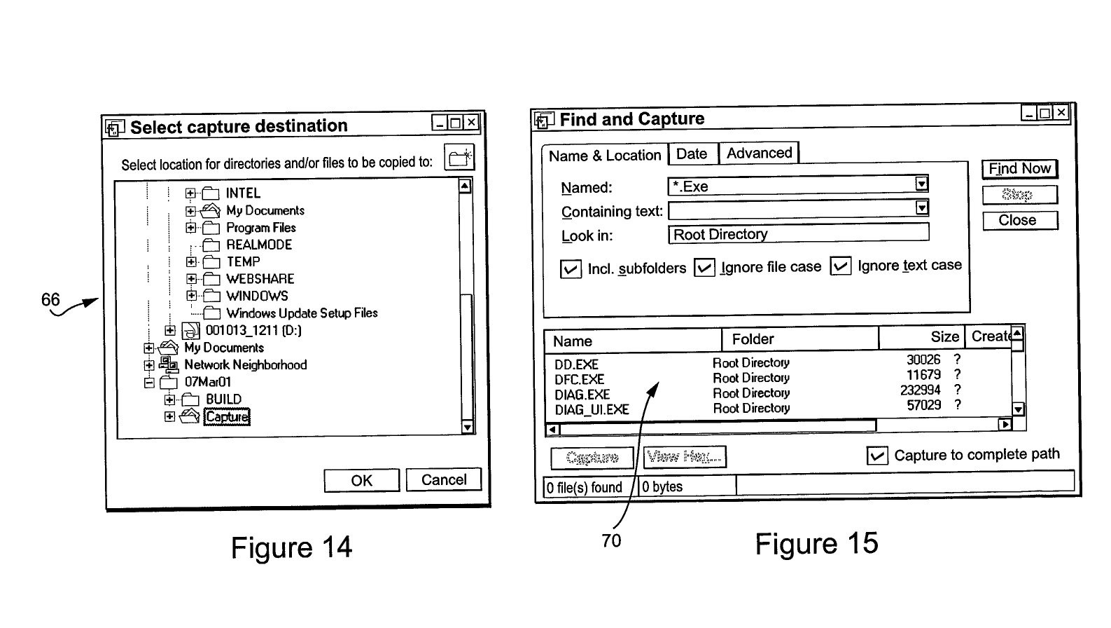

The File System Analyser display 52 includes a “Node Capture” function 64 for capturing the contents of the currently highlighted nodes of the tree structure to enable hexadecimal/ASCII editing of corrupted areas, and to capture the contents of new file systems that are yet to be promulgated to extend the useful life of the program. When selected, the “Node Capture” function 64 opens a Select Capture Destination display 66, as shown in FIG. 14. The Select Capture Destination display 66 allows the user to browse through the analysis computer 12 to thereby select an appropriate directory for the data recovered from the clone hard disk 20. The directory selected is, for example, a subdirectory of the catchment hard disk 22.

The File System Analyser display 52 also includes a “Find/Capture” function 68 for selectively capturing files and/or directories and saving them in the selected destination directory. The user highlights a file or a directory and then executes the “Find/Capture” function 68 by clicking on the respective button and the analysis program 28 then generates a Find and Capture display 69 for the user, as shown in FIG. 15.

The Find and Capture display 69 provides a “Windows Explorer” type listing 70 of all directories and files that stem from the selected directory, or, in the case where a file was selected, the selected file. The user is able to search through a particular directory, using standard Windows search mechanisms, and capture selected files and/or directories to the designated capture destination defined above. The user may also view a file using the Hexidecimal/ASCII editor 46.

The contents of the designated capture directory on the catchment hard disk 22 is listed in a “Windows Explorer” type manner in a capture partition window 72 in the Data Recovery display 42.

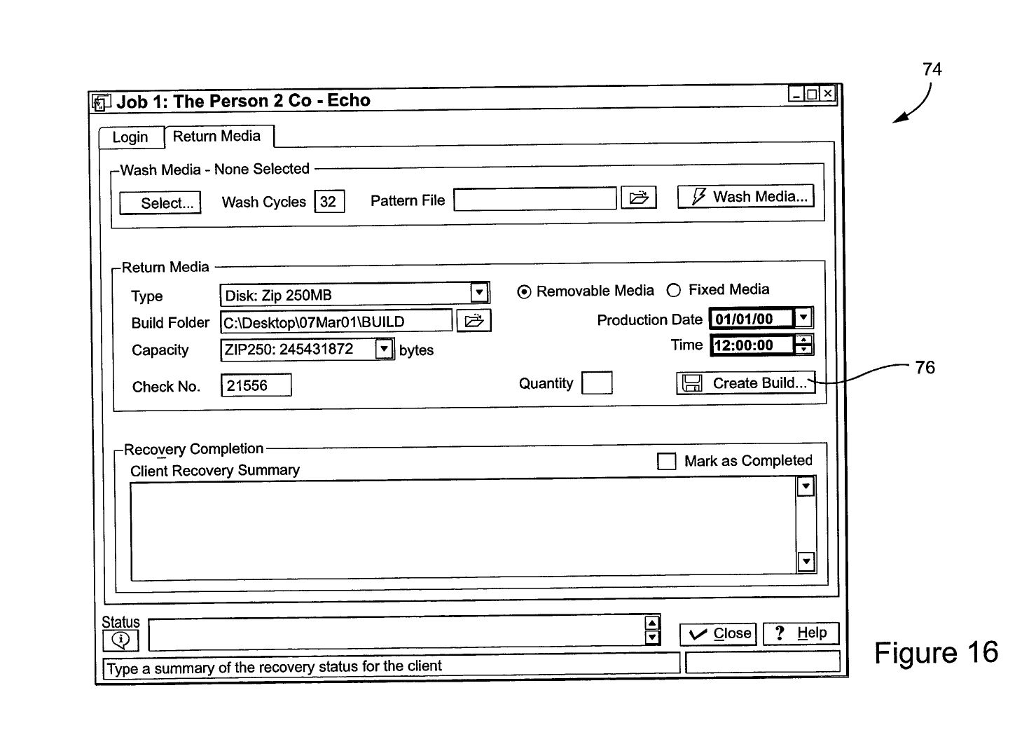

Once the client hard disk 14 has been sufficiently recovered, a user of the computer analysis may access a Return Media display 74, as shown in FIG. 16, to create return media for a client. The Return Media display 74 requires the user to specify the following:

Return media type;

Location of the build directory;

Capacity of return media; and

Removable return media or Fixed return media.

The analysis program 28 parses the saved data to a set of definable directories by examining the captured data on the catchment hard disk 22 to determine what data it is expecting to receive and then recursively collecting it into a build directory until all of the expected data is accounted for.

Once all data is accounted for, a group of new subdirectories is created by the analysis system 28. Each subdirectory holds an amount of data that reflects the amount of data which can be held on the respective individual return media types.

For example, if the return data for a recovered 2 Gigabyte (2000 Mb) hard drive was to be placed on to CDs for transportation, each sub directory would hold no more than 640 Mb (the amount of data able to be held by a CD). The computer analysis program 28 would therefore create directories in the following form:

| | | | |
|---|---|---|---|
| Disk 1 = | Disk 2 = | Disk 3 = | Disk 4 = |
| 620 Mb | 625 Mb | 615 Mb | 140 Mb |

A user with full access rights to the analysis program 28, who is not an administrator, will have access to Client Contact screen 34; the Client Data screen 36; the Media Select module 38; the Replication Screen 44; the Data Recovery module 52 and the Return Media module 70, as shown in FIG. 5

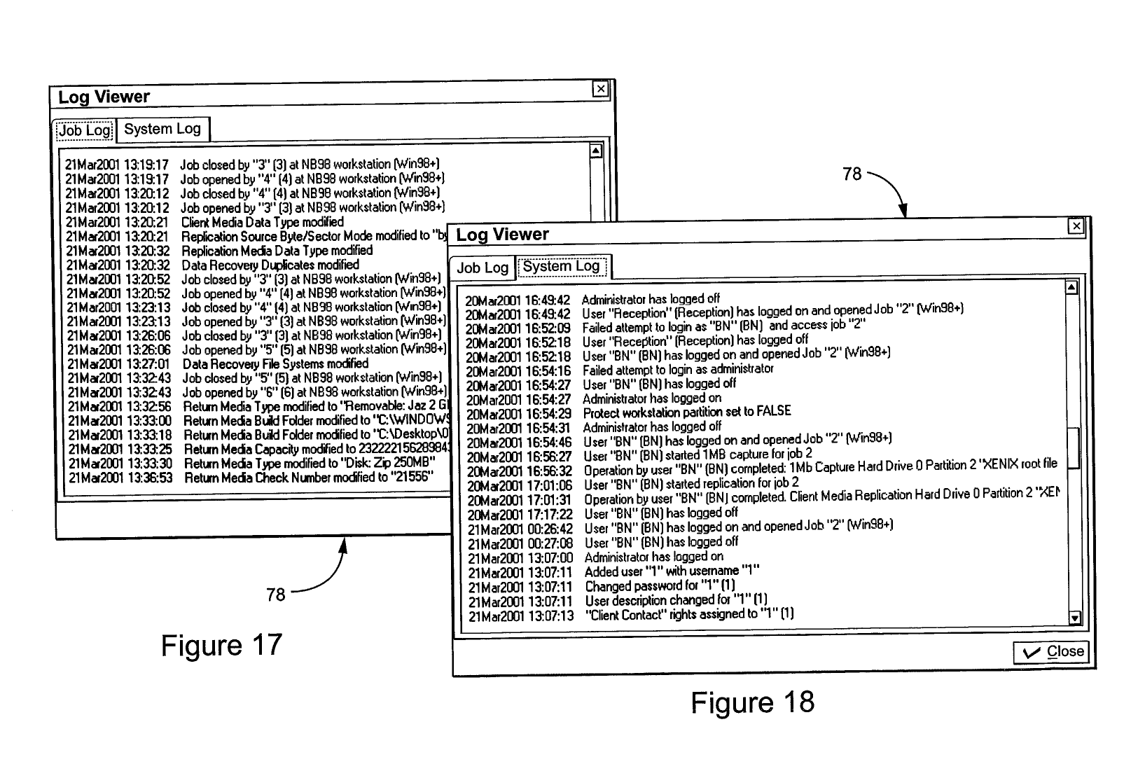

The analysis program 28 maintains a tamper proof log 78, as shown in FIGS. 17 and 18, for all work performed on the computer analysis system 10.

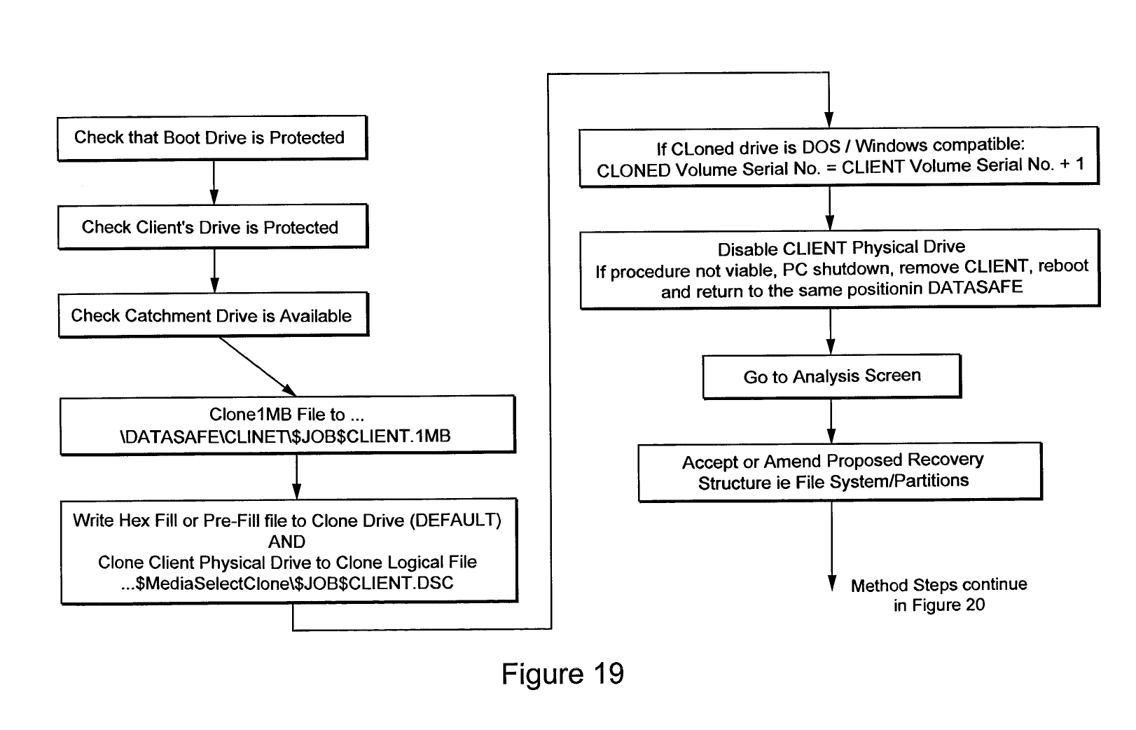

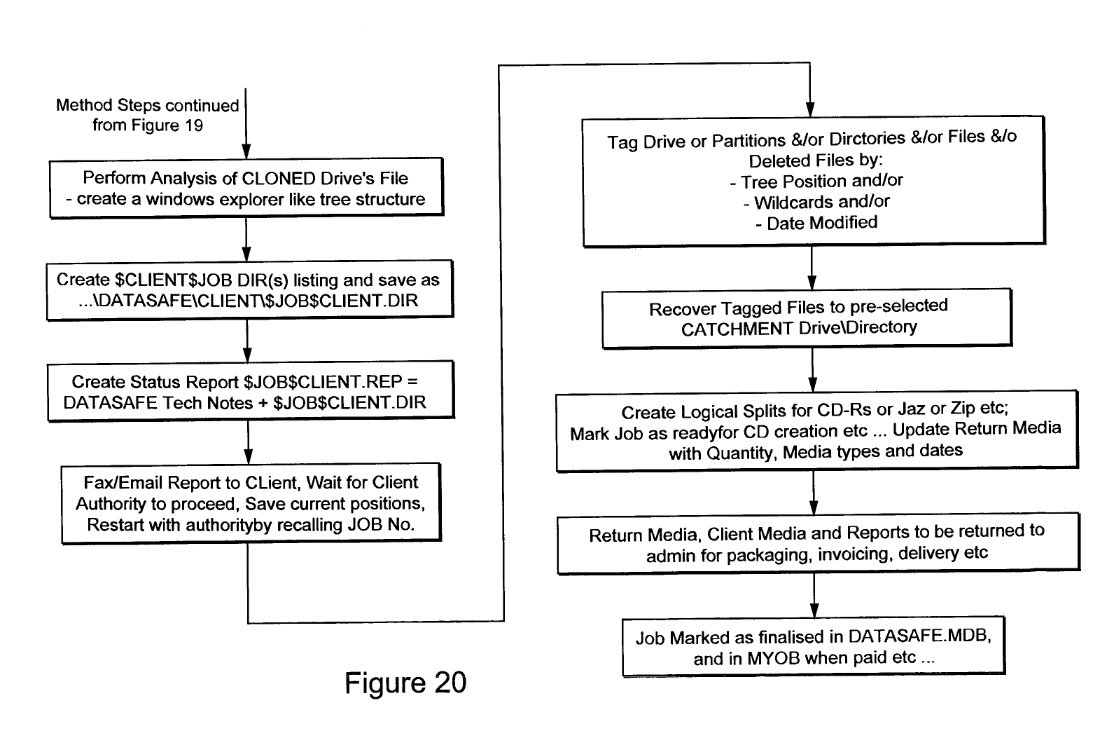

The steps executed by the computer analysis system 10, and in particular the data analysis program, are set out for one embodiment in FIGS. 19 and 20.

The computer analysis system is particularly advantageous as it enables an exact binary replicate of the binary bits of large hard disks, to be obtained without any additional data being added or changed or deleted. This binary replicate is stored as a single file, even for large hard disks of 100 Gb in size. The analysis program is then able to parse the file once a selection of the file system for the client hard disk is made. On selecting the file system, the file is parsed and treated as a virtual drive so as to rebuild the file structure for the client disk. This can be done on the analysis system for a variety of operating systems and file systems, and in particular possible operating systems and file systems of the client hard disk do not pose any constraints, nor require a number of machines to be available. The recovered data can then be returned on selected storage media.

The claims defining the invention are as follows:

1. A data analysis system, including:
means for retrieving a binary image of a first data storage medium, the image being an unaltered binary replica of the bits of the first storage medium;
means for storing the image on a second storage medium, the image being stored as a single binary file on the second storage medium; and
means for analysing said image on said second storage medium.

2. A data analysis system claimed in claim 1, wherein the means for analysing includes means for identifying an operating system and file structure of said image.

3. A data analysis system as claimed in claim 2, where the means for analysing includes means for identifying at least one of the following features of said image:
(a) Boot Sector(s);
(b) Partition Table(s);
(c) File Allocation Table(s);
(d) Master File Table(s);
(e) File Entry Table(s);
(f) Root Directories;
(g) Child Directories;
(h) Files;
(i) File Fragments;
(j) Deleted Data Directories; and
(k) Orphaned Data Directories.

4. A data analysis system as claimed in any one of the preceding claims, including means for recovering data from the image in a form readable by an operating system and storing the recovered data on a third data storage medium.

5. A data analysis system as claimed in claim 4, including means for parsing said image into a plurality of directories.

6. A method of data analysis, including the steps of:
retrieving a binary image of a first data storage medium, the image being an unaltered binary replica of the bits of the first storage medium;
storing the image on a second storage medium, the image being stored as a single binary file on the second storage medium; and
analysing the image on the second storage medium.

7. A method claimed in claim 6, wherein the step of analysing includes the step of identifying an operating system and file structure of said image.

8. A method claimed in claim 7, where the step of analysing includes the step of identifying at least one of the following features of said image:
(a) Boot Sector(s);
(b) Partition Table(s);
(c) File Allocation Table(s);
(d) Master File Table(s);
(e) File Entry Table(s);
(f) Root Directories;
(g) Child Directories;
(h) Files;
(i) File Fragments;
(j) Deleted Data Directories; and
(k) Orphaned Data Directories.

9. A method claimed in any one of claims 6 to 8, including the steps of recovering data from the image in a form readable by an operating system and storing the recovered data on a third data storage medium.

10. A method claimed in claim 9, including the step of parsing said image into a plurality of directories.

11. A data analysis method, including the steps of:
accessing a binary file comprising a binary image of the binary bits of a data storage medium; and
identifying an operating system and file structure of said image.

12. A method claimed in claim 11, including the step of identifying at least one of the following features of said image:
(a) Boot Sector(s);
(b) Partition Table(s);
(c) File Allocation Table(s);
(d) Master File Table(s);
(e) File Entry Table(s);
(f) Root Directories;
(g) Child Directories;
(h) Files;
(i) File Fragments;
(j) Deleted Data Directories; and
(k) Orphaned Data Directories.

13. A method claimed in claims 11 or claim 12, including the steps of recovering data from the image in a form readable by an operating system and storing the recovered data on a further data storage medium.

14. A method claimed in claim 13, including the step of parsing said image into a plurality of directories.

15. A method claimed in claim 14, including the step of storing said file structure and recovered data on return media.

16. A data recovery system, including:
means for retrieving a binary image of a first data storage medium, the image being an unaltered binary replica of the bits of the first storage medium; and
means for storing the image on a second storage medium, the image being stored as a single binary file on the second storage medium.

17. A data recovery system claimed in claim 16, including means for analysing said image on said second storage medium.

18. A data recovery system claimed in claim 17, wherein the means for analysing includes means for identifying an operating system and file structure of said image.

19. A data analysis system as claimed in claim 18, where the means for analysing includes means for identifying at least one of the following features of said image:
(a) Boot Sector(s);
(b) Partition Table(s);
(c) File Allocation Table(s);
(d) Master File Table(s);
(e) File Entry Table(s);
(f) Root Directories;
(g) Child Directories;
(h) Files;
(i) File Fragments;
(j) Deleted Data Directories; and
(k) Orphaned Data Directories.

20. A data recovery system as claimed in any one of claims 16 to 19, including means for recovering data from the image in a form readable by an operating system and storing the recovered data on a third data storage medium.

21. A data recovery system as claimed in claim 20, including means for parsing said image into a plurality of directories.
